(19) United States
(12) Patent Application Publication
(10) Pub. No.: US 2018/0116896 A1
(43) Pub. Date: May 3, 2018

(54) VERTICAL INTEGRATED TRACTION SYSTEM

(71) Applicant: ROCK LIFE ACADEMIC INC., Fremont, CA (US)

(72) Inventors: Guangzhe Chang, Fremont, CA (US); Wenxing Quan, Fremont, CA (US)

(73) Assignee: ROCK LIFE ACADEMIC INC., Fremont, CA (US)

(21) Appl. No.: 15/590,772

(22) Filed: May 9, 2017

(30) Foreign Application Priority Data
Nov. 2, 2016 (CN) MU1616645

(51) Int. Cl. A61H 1/02

(52) U.S. Cl. CPC A61H 1/0292; A61H 1/0229; A61H 2201/1604; A61H 2201/1619; A61H 2205/04; A61H 2201/1652; A61H 2203/0487; A61H 2205/081; A61H 2201/164

(57) ABSTRACT

Disclosed herein are vertical traction systems and methods of using the vertical traction systems to treat both bones and muscles in a normal working state. In one embodiment, a vertical traction system includes a frame, a load-bearing assembly, and a spinal traction assembly. The load-bearing assembly is coupled to the frame, and is configured to move vertically and support a subject under treatment in an upright position while the load-bearing assembly moves vertically. The spinal traction assembly is coupled to the frame, and is configured to pull the cervical or lumbar spine of the subject.

### CROSS-REFERENCES TO RELATED APPLICATIONS

This application claims the benefit of Chinese Utility Model Application No. MU1616645, filed on Nov. 2, 2016, the contents of which is hereby incorporated by reference in its entirety for all purposes.

### BACKGROUND OF THE INVENTION

Traction physiotherapy instruments can be used for adjusting spine (e.g., lumbar spine or cervical spine) and treating patients with bone and/or muscle pains. Most traction physiotherapy instruments for lumbar spine traction on the market are bed-style lateral traction systems, and most traction physiotherapy instruments for cervical spine traction on the market are seat-style systems. In many cases, it may be difficult for patients with pains in the lumbar spine to lie down on the lateral traction systems, or for patients with pains in the cervical spine to sit down or stand up. Thus, the risk of secondary injury during the treatment may be significant when using such traction systems. In addition, during the treatment using lateral traction systems, the muscles, including both the uninjured and the injured muscles, are generally in a relaxed state, rather than in a normal working state. Thus, the treatments performed using the lateral traction systems may not be the appropriate treatment needed for the working state. The lateral traction systems or seat-style traction systems may also have a large footprint and may take a large space.

### SUMMARY OF THE INVENTION

The present application relates generally to traction physiotherapy instruments, and more particularly, to vertical traction systems and methods of using the vertical traction systems to treat both bones and muscles in a normal working state. A vertical traction system may provide a fixation unit for securing a patient in an upright standing position on the vertical traction system, and a load-bearing assembly for moving the patient up and down while the patient remains in the upright standing position. Thus, the patient under the traction therapy is in an upright standing posture. The lumbar spine can be pulled downwards by the weight of the lower portion of the patient's body or an additional lumbar traction assembly. The cervical spine can be pulled upwards with the patient in the upright position as well. As such, the patient does not need to lie down for the treatment.

According to an embodiment of the present invention, a vertical traction system includes a frame, a load-bearing assembly, and a cervical traction assembly and/or a lumbar traction assembly. The load-bearing assembly may be coupled to the frame and can be moved vertically to lift a patient off the ground. The load-bearing assembly may include a pair of handrails that can support the patient at, for example, the arms or armpits. The load-bearing assembly may also include a fixation unit for fixing the patient's waist or chest. The lumbar traction assembly may be coupled to the frame and may be used to pull the patient downwards at the legs or feet. The cervical traction assembly may be used to pull the head of the patient upwards for cervical traction.

According to another embodiment of the present invention, a vertical traction system is provided. The vertical traction system may include a frame, a load-bearing assembly, and a spinal traction assembly. The load-bearing assembly may be coupled to the frame, and may be configured to move vertically and support a subject under treatment in an upright position while the load-bearing assembly moves vertically. The spinal traction assembly may be coupled to the frame, and may be configured to pull the cervical or lumbar spine of the subject.

According to another embodiment of the present invention, a method of operating a vertical traction system may include attaching a subject in an upright position to the vertical traction system, and activating the vertical traction system to (1) pull the head or the upper body of the subject upwards or (2) remove a support to a foot of the subject, while the subject remains in the upright position, to apply a force on at least a portion of the spine and associated muscles of the subject.

Numerous benefits are achieved by way of the present invention over conventional techniques. For example, embodiments of the present invention provide systems and methods for simultaneous treatment of bones and muscles that may affect the functions of each other. The systems and methods can be used to treat bones and muscles at the cervical, thoracic, and lumbar spines. Rather than only treating one part of the body as in the manual treatment, multiple parts of the cervical, thoracic, and lumbar spines may be treated independently or jointly at the same time or during different times. The patient can be treated in an upright standing position, and thus reducing the risk of secondary injury that the patient may suffer when lying down on a lateral traction system. In the upright standing position, the bones and muscles can be treated while they are in a normal working condition, rather than a relaxed condition, and thus the treatment can more effectively target bones and muscles that do not function properly during the normal working condition. Furthermore, a treatment recipe can be programmed on the vertical traction system and be more precisely controlled, and thus more consistent treatment results may be achieved. In addition, due to the vertical configuration, the footprint of the vertical traction system may be small, and therefore the vertical traction system may be installed in a limited space or more vertical traction systems may be installed at a given space. These and other embodiments of the invention along with many of its advantages and features are described in more detail in conjunction with the text below and attached figures.

### BRIEF DESCRIPTION OF THE DRAWINGS

FIG. 1 is a simplified schematic diagram of an example vertical traction system, according to an embodiment of the present invention.

FIG. 2 is a simplified schematic diagram of a fixation unit, according to an embodiment of the present invention.

FIG. 3 is a simplified schematic diagram of a load-bearing unit, according to an embodiment of the present invention.

FIG. 4 is a simplified diagram illustrating an example vertical traction system, according to an embodiment of the present invention.

FIG. 5 is a simplified diagram illustrating an example vertical traction system with a patient under treatment, according to an embodiment of the present invention.

FIG. 6 is a simplified diagram illustrating an example vertical traction system, according to an embodiment of the present invention.

FIG. 7 is a simplified schematic diagram of an example vertical traction system, according to an embodiment of the present invention.

FIG. 8 is a simplified flowchart illustrating a method of using a vertical traction system, according to an embodiment of the present invention.

FIG. 9 is a simplified block diagram of an example computing system for implementing some of the examples described herein.

### DETAILED DESCRIPTION OF SPECIFIC EMBODIMENTS

The present invention relates generally to a vertical traction system for treating, for example, lumbar and/or cervical spines and associated muscles. Patients with degenerative spine conditions or spinal compression may benefit from spinal traction therapy performed by chiropractors or physical therapists. Spinal traction is a form of decompression therapy that stretches the muscles and bones, and relieves pressure on the discs of the spine, which straightens the spine and improves the body's ability to heal itself. Spinal traction can be used to treat herniated discs, sciatica, degenerative disc disease, pinched nerves, and many other back conditions. Spinal traction can generally be performed manually or mechanically.

Most mechanical traction physiotherapy instruments for lumbar spine traction available on the market are bed (or table)-style lateral traction systems, also called traction beds or tables. A patient may need to lie down on the back or on the stomach on a lateral traction system. Most traction physiotherapy instruments for cervical spine traction on the market are seat-style. In many cases, it may be difficult for patients with back pains to lie down on the lateral traction systems, or for patient with neck pain to sit down or stand up. Lying or sitting down, and getting up may also increase the pain and the risk of secondary injury. Furthermore, during the treatment using lateral traction systems, the muscles, including both the uninjured and the injured muscles, are generally in a relaxed state, rather than in a normal working state. Thus, the treatments performed using the lateral traction systems may not be the appropriate treatment needed for the normal working state. In addition, the lateral traction systems or seat-style traction systems may have a large footprint and may take a large space.

Spinal traction may be performed manually on a patient in an upright position by a physical therapist. The effects of manual spinal traction on a patient in the upright position may be significant, but the manual treatment may not last long enough to achieve the desire results. The results of manual spinal traction may vary from physician to physician, and the cost of manual spinal traction may be high.

Techniques disclosed herein provide systems and methods for simultaneously treating bones (e.g., spine) and muscles in a working condition while a subject under treatment is in an upright position. More specifically, a vertical traction system that can pull the spine of a patient vertically (upwards and/or downwards) is provided. The vertical traction system may include a frame, a load-bearing assembly coupled to the frame for lifting the subject in the upright position, and one or more traction assemblies that can be coupled to one or more body parts of the subject and can be moved vertically to pull the corresponding body parts upwards or downwards. The load-bearing assembly and the traction assemblies may be controlled and coordinated by a control subsystem to apply a desired amount of pulling force at a desired speed to different body parts according to a pre-programmed treatment recipe. The vertical traction system can be used to treat, for example, cervical spine, thoracic spine, and lumbar spine. The vertical traction system can significantly reduce the risk of second injury during treatment, improve the therapeutic effects, and reduce the time for recovery.

### I. Vertical Traction Systems

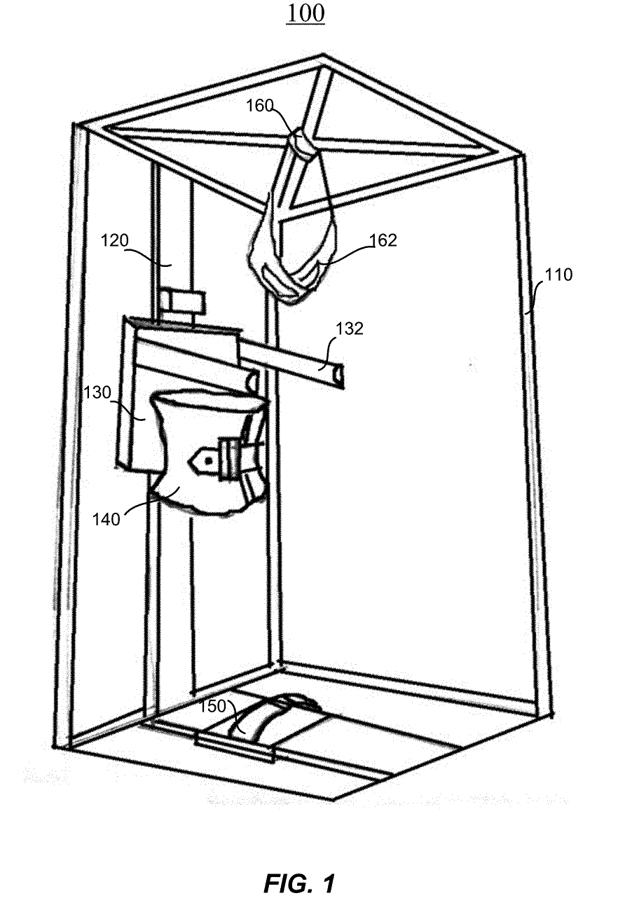

FIG. 1 is a simplified schematic diagram of an example vertical traction system 100, according to an embodiment of the present invention. Vertical traction system 100 may include a frame 110, a load-bearing assembly 130, and a cervical traction assembly 160. Frame 110 may include wheels and a docking system that can be used to move and fix vertical traction system 100 at a desired location. Frame 110 may include a guide rail 120. Load-bearing assembly 130 may be configured to move up or down along guide rail 120. Load-bearing assembly 130 may include a pair of handrails 132 and one or more fixation units 140. A fixation unit 140 may be used to attach a patient to load-bearing assembly 130 at, for example, the chest or the waist, such that the patient may be held at a stable and secure position when being lifted upright by load-bearing assembly 130. Handrails 132 may be used to at least partially support the patient in an upright position under the arms of the patient to lift the patient up or down when load-bearing assembly 130 moves vertically.

Cervical traction assembly 160 may include a sling 162 comprising a fabric, leather, synthetic, or other soft materials. Sling 162 may be configured to hold the patient's head at the neck or the chin. Sling 162 can be pulled up relative to load-bearing assembly 130 to pull the head upwards with respect to the other parts of the body, in order to pull the cervical spine of the patient. In some implementations, cervical traction assembly 160 may include a component other than a sling, such as a helmet, for pulling the patient upwards at the head.

In some implementations, vertical traction system 100 may also include a lumbar traction assembly 150. Lumbar traction assembly 150 may be used to pull the patient downwards at the feet or legs to pull the lumbar spine and/or the thoracic spine when the patient is lifted up by the handrails under the arm, and the feet are at least partially off the ground and are not supporting the full weight of the patient's body. In some implementations, lumbar traction assembly 150 may not be used, as the lumbar spine and/or the thoracic spine may be pulled down by the lower part of the body due to gravity (which may provide enough traction force) when the patient is lifted off the ground.

In this way, vertical traction system 100 may be used to apply traction to any part of the spine including cervical spine, thoracic spine, and lumbar spine, and the associated muscles, tendons, and ligaments, while the patient is in an upright standing position. The traction can be performed to different parts of the spine independently or jointly, at different times or at the same time. The various moving parts of vertical traction system 100, such as load-bearing assembly 130 and cervical traction assembly 160, and may be operated by various actuators mechanically or electromechanically, and thus the treatment can be as long as desired.

### A. Load-Bearing Assembly

As described above, load-bearing assembly 130 may be coupled to guide rail 120 and be used to hold and support the patient when load-bearing assembly 130 is moved up and down along guide rail 120 by an actuator. Load-bearing assembly 130 may include handrails 132 for supporting the patient while the patient is at least partially off the ground. Handrails 132 may have a circular, elliptical, or other shape in the cross-section and may include appropriate materials such that the patient may be supported under the armpits comfortably by handrails 132. Handrails 132 may be flat, tilted, or of a curved shape. The locations of handrails 132 on load-bearing assembly 130 may be adjusted to better fit the patient. Fixation unit 140 may be included on load-bearing assembly 130 or separate from load-bearing assembly 130 to hold the patient in the appropriate position for treatment.

1. Fixation Unit

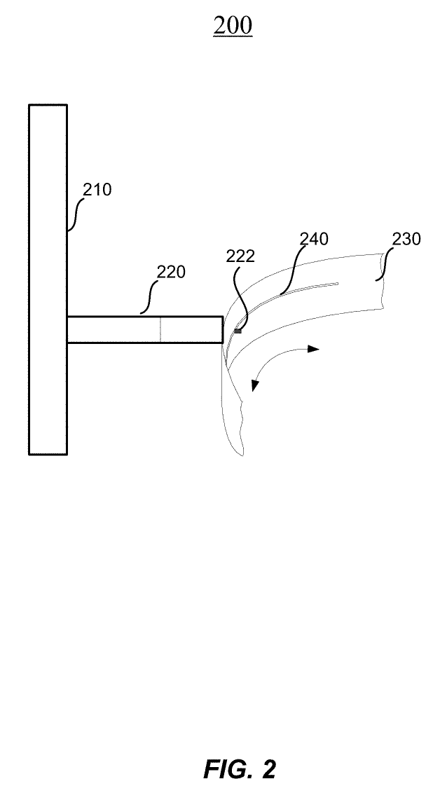

FIG. 2 is a simplified schematic diagram of a fixation unit 200, according to an embodiment of the present invention. Fixation unit 200 may include an extendable rod 220 and a binding unit 230. Fixation unit 200 may be coupled to a support plate 210 of a load-bearing assembly through extendable rod 220, which may be, for example, a telescopic rod. Binding unit 230 may be fixedly or movably coupled to extendable rod 220. For example, in some implementations, binding unit 230 may include a plurality of spaced-apart fixing plates for fixedly connecting to one or more extendable rods 220. In some implementations, binding unit 230 may include a sliding rail 240 and extendable rod 220 may include a matching component 222, such that binding unit 230 can be adjusted along sliding rail 240 with respect to matching component 222 on extendable rod 220. Binding unit 230 may include a material such as a leather, a fabric, or a synthetic material, and may be embedded with metal strings for reinforcement. Binding unit 230 may be in the form of one or more belts, straps, or bands, and may include fasteners, such as clips, Velcro fasteners, hooks, snap fasteners, etc.

When a patient is to be treated on a vertical traction system, the vertical position of the load-bearing assembly may be adjusted such that the handrails can be at a position at or lower than the armpits of the patient. Based on the sizes and figure of the patient, extendable rod 220 may be adjusted (extended or contracted), and/or binding unit 230 may be adjusted along sliding rail 240 accordingly, to maintain the patient in the appropriate position for treatment.

2. Actuator Unit

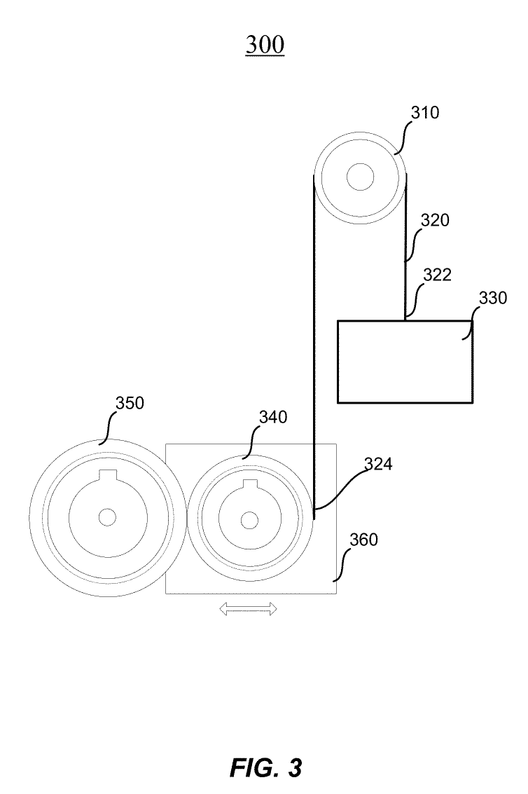

FIG. 3 is a simplified schematic diagram of an example actuator unit 300 that can be used to operate on a moving part 330 of a vertical traction system, such as load-bearing assembly 130, cervical traction assembly 160, or lumbar traction assembly 150 of FIG. 1, according to an embodiment of the present invention. Actuator unit 300 may include a pulley 310 positioned on an upper portion of the frame of the vertical traction system, a reel 340, and a connection device 320. In some implementations, actuator unit 300 may include a motor (not shown in FIG. 3) coupled to reel 340. In some implementations, a handle that can be manually operated, rather than the motor, may be used in actuator unit 300. Connection device 320 may be a cable, a rope, or a chain of an appropriate material, such as rubber or metal (e.g., steel). One end of connection device 320 may be coupled to moving part 330. Connection device 320 may be routed over pulley 310 and coupled to reel 340 at the other end of connection device 320.

In some implementations, reel 340 may be directly coupled to the output shaft of the motor, such as an electric motor. The motor, when rotating in one direction, may cause connection device 320 to wrap around reel 340, thus pulling moving part 330 closer to pulley 310. When the motor rotates in the other direction, it may cause connection device 320 to unwrap around reel 340, and thus releasing moving part 330 from pulley 310. Since pulley 310 can be fixed at the upper portion of the frame of the vertical traction system, the motor can move moving part 330 up or down by rotating in a corresponding direction.

In some implementations, reel 340 may be coupled to the output shaft of the motor through a first gear 350. Reel 340 may include a second gear that can mesh with first gear 350, which can be connected to the output shaft of the motor. Thus, when the motor rotates, first gear 350 may rotate with the motor and cause the second gear and reel 340 to rotate, thus pulling or releasing moving part 330.

In some implementations, the second gear of reel 340 may be coupled to first gear 350 to form a clutch. The clutch may be used to make immediate response to the cervical or lumbar traction applied, when a patient receiving cervical or lumbar traction therapy is not able to endure the cervical or lumbar traction applied. One of reel 340 and first gear 350 may be fixed to the frame, and the other one of reel 340 and first gear 350 may be positioned on a movable mounting plate, such that first gear 350 and the second gear may be engaged with or disengaged from each other when the mounting plate is moved. In some implementations, the clutch can be driven manually using a level, where a first end of the level may be used to toggle a movable gear or mounting plate, and the second end of the level may be a handle than can be moved by hand. In some implementations, the second end of the level may be driven by an electric driver that can be activated by a button or a switch on a portion of the vertical traction system reachable by the patient while being supported by the load-bearing assembly. In this way, the patient may pull the level manually or use the button or switch to disengage the second gear of reel 340 from the first gear 350 when the patient cannot or would not want to endure the degree of cervical or lumbar traction applied, such that the rotation of reel 340 would not be restricted by the motor, and connection device 320 can be unwrapped from reel 340 as a result of gravity of the patient and/or moving part 330 to quickly release moving part 330.

In some implementations, one end of connection device 320 may be fixed to a portion of the frame of vertical traction system, and the other end of connection device 320 may be coupled to moving part 330 through a motor, and reel 340 and/or first gear 350 may be coupled to or on the moving part 330. For example, the motor, and reel 340 and/or first gear 350 may be installed on the load-bearing assembly, where, for example, at least one of the motor, reel 340, and first gear 350 may be fixed to the load-bearing assembly. Thus, when the motor drives reel 340 to rotate, connection device 320 may be wrapped around or released from reel 340 to change the distance between pulley 310 and moving part 330, and thus the height or position of moving part 330 with respect to the frame.

In some implementations, the motor may be a step motor. In some implementations, the motor may be replaced with a pneumatic cylinder or a hydraulic cylinder, and the corresponding pneumatic cylinder or hydraulic cylinder may directly pull moving part 330 using connection device 320 without wrapping connection device 320 around a reel.

In some implementations, the actuator unit may include two or more gears coupled together. The two or more gears can be used to adjust the speed and/or force for pulling connection device 320 by using different gears for a given power of the motor. In some implementations, the speed/or force for pulsing connection device 320 may be controlled by controlling the speed and/or power of the motor. In some implementations, actuator unit 320 may be manually operated rather than using a motor.

The above description of example embodiments of the actuator unit has been presented for the purposes of illustration and description. It is not intended to be exhaustive or to limit the invention to the precise form described, and those skilled in the art can appreciate that many modifications and variations are possible in light of the teaching above.

### B. Cervical Traction Assembly

As described above, a cervical traction assembly, such as cervical traction assembly 160 of FIG. 1, may include a sling comprising a fabric, leather, synthetic, or other soft material and configured to hold a patient's head at the neck or the chin. In some implementations, the cervical traction assembly may include a component other than a sling, such as a helmet, for holding the patient's head. The component for holding the patient's head may be moved vertically by an actuator unit as described above with respect to FIG. 3.

In some implementations, a first end of the connection device (e.g., connection device 320) of the actuator unit may be coupled to the component for holding the patient's head. The connection device may be routed over a pulley (e.g., pulley 310) located at an upper portion of the frame of the vertical traction system, and a second end of the connection device may be coupled to a reel that may be driven by a motor. When the motor causes the reel to rotate in one direction, the connection device may be wrapped around the reel to pull the component for holding the patient's head closer to the pulley, such that the head of the patient may be pulled upwards with respect to the other parts of the body, in order to pull the cervical spine of the patient. When the motor causes the reel to rotate in the opposite direction, the component for holding the patient's head may be released to lower down the patient's head.

As described above with respect to FIG. 3, the actuator unit for the cervical traction assembly may include two or more gears that can be selectively engaged or disengaged. When engaged, the gears may be used to pull or release the component for holding the patient's head, for example, driven by a motor at a selected speed or force. When the two or more gears are disengaged, the component for holding the patient's head may be released quickly. The patient may be able to disengage the two or more gears, for example, manually using a level, or by pushing a button or turning on a switch, to avoid applying excessive force to the cervical spine and/or the associated muscles.

In some implementations, the cervical traction assembly, such as cervical traction assembly 160 of FIG. 1, may include a fail-safe structure that may be triggered by, for example, an excessive force. For example, the actuator unit for the cervical traction assembly may include a lock that may be unlocked by the excessive force. When the lock is in place, the actuator unit for the cervical traction assembly may operate under the control of the gears as described above. When an excessive force is applied through, for example, connection device 320, the lock may be unlocked, such that connection device 320 may be released and moving part 330 may drop quickly to avoid injury to the cervical spine.

In various implementations, the actuator unit for the cervical traction assembly may include various combinations of the features of actuator unit 300 described above with respect to FIG. 3.

### C. Lumbar Traction Assembly

In some implementations, the vertical traction machine may further include a lumbar traction assembly, such as lumbar traction assembly 150 shown in FIG. 1. The lumbar traction assembly may be used to pull the lower portion of the patient's body downwards (e.g., at the feet or legs) to pull the lumbar spine and/or the thoracic spine when the patient is lifted up by the handrails under the arm, and the feet are at least partially off the ground and are not supporting the full weight of the body. The lumbar traction assembly may include one or more blocks of the same or different weights, and the one or more blocks may be added to or removed from one or more slots of the lumbar traction assembly as needed, to apply a desirable pulling force to improve the effectiveness of the treatment.

In some implementations, the one or more blocks may be moved vertically by an actuator unit, such as the one described above with respect to FIG. 3. For example, in some implementations, a first end of the connection device (e.g., connection device 320) of the actuator unit may be coupled to a structure that holds the blocks. The connection device may be routed over a pulley (e.g., pulley 310) located on the frame of the vertical traction system, and a second end of the connection device may be coupled to a reel that may be driven by a motor. When the motor causes the reel to rotate in one direction, the connection device may be unwrapped around the reel to gradually release the structure that holds the blocks from the pulley, such that the lower portion of the patient's body may be pulled away from other parts of the body in order to pull the lumbar spine or the thoracic spine of the patient. When the motor causes the reel to rotate in the opposite direction, the structure that holds the blocks may be pulled up to reduce the pulling force of the blocks on the lumbar spine or the thoracic spine of the patient.

As described above with respect to FIG. 3, the actuator unit for the lumbar traction assembly may include two or more gears that can be selectively engaged or disengaged. When engaged, the gears may be used to pull or release the structure that holds the blocks, for example, by a motor, at a selected speed or force. When the two or more gears are disengaged, the structure that holds the blocks may be pulled more quickly. The patient may be able to disengage the two or more gears, for example, manually using a level, or by pushing a button or turning on a switch, to avoid applying excessive force to the lumbar or thoracic spine and/or the associated muscles of the patient.

In various implementations, the actuator unit for the lumbar traction assembly may include various combinations of the features of actuator unit 300 described above with respect to FIG. 3.

### D. Other Components

In some implementations, the vertical traction system may include various other components that may assist the traction treatment. For example, in some implementations, the vertical treatment system may include infrared heater or magnetic field generator that may be used to perform thermal or magnetic treatment on the muscles. In some implementations, the vertical treatment system may include a massage subsystem. In some implementations, the vertical treatment system may include a monitoring subsystem for monitoring the vital signs of the patient, such as the body temperature, heartbeat rate, or blood pressure, etc.

### E. Control Subsystem

In some implementations, the vertical traction system may include a control subsystem for controlling the operations of various components of the vertical traction system, such as the load-bearing assembly, the cervical traction assembly, and/or the lumbar traction assembly. For example, the control subsystem may be used to control the engagement or disengagement of the gears for various actuator units by controlling the electric drivers of the actuator units. The patient or medical personnel may manually control the electric driver of the actuator units through a user interface of the control subsystem, such as a keyboard, control panel, or touch screen.

In some implementations, the control subsystem may include computer system comprising one or more processors and memory. A patient-specific treatment recipe may be stored in the memory as computer-readable instructions that can be executed by the one or more processors. The patient-specific treatment recipe may include, for example, the physical parameters of the patient, the desired pulling force, pulling speed, and the maximum extension for different body parts, the number of pulling cycles at each selected pulling force and speed, etc. The patient-specific treatment recipe may also include the treatment recipes for a series of treatments.

When a patient is to be treated on a vertical traction system, the patient-specific treatment recipe may be loaded on the vertical traction system, and the one or more processors may execute the instructions to set the initial condition of the load-bearing assembly, the fixation units, the cervical traction assembly, the lumbar traction assembly, and/or other components of the vertical traction system, based on, for example, the desired pulling force, pulling speed, and the maximum extension for different body parts, and the physical parameters of the patients, such as the height, weight, chest circumference, waist circumference, etc. The patient can then be positioned on the vertical treatment system at a desired posture for treatment at the instructions of the medical personnel or the instructions given through the user interface of the control subsystem. Once the patient is properly positioned and secured to the vertical traction system, the control subsystem can then start the treatment based on the patient-specific treatment recipe.

In this way, the treatment can be more precisely controlled and monitored, and more consistent treatment results may be achieved. A patient may use any vertical traction system at any location to receive same or similar treatment by loading the patient-specific treatment recipe to the vertical traction system. The patient-specific treatment recipe may be adjusted based on the progress of the recovery of the patient during the treatment process.

### F. Other Embodiments

Designs and configurations of the vertical traction system can be varied by those skilled in the art based on the teachings of the present disclosure. Several example embodiments of the vertical traction systems are described below for illustration purposes rather than for limiting the invention to the specific embodiments.

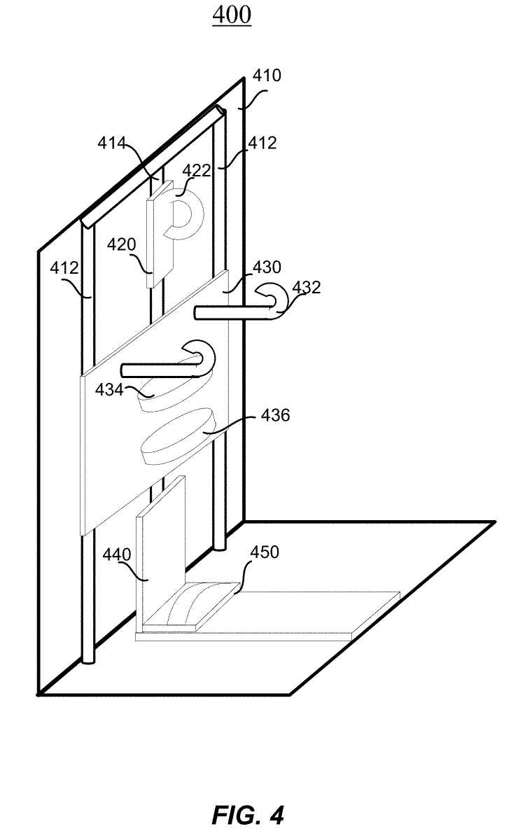

FIG. 4 is a simplified diagram illustrating an example vertical traction system 400, according to an embodiment of the present invention. As vertical traction system 100, vertical traction system 400 may include a frame 410 that may include one or more guide rails 412 and/or 414. In some implementations, two guide rails 412 may be used. In some implementations, one or more guide rails 414 may be used. In some implementations, one or more guide rails 412 and 414 may be used.

Vertical traction system 400 may include a load-bearing assembly 430 that may include handrails 432, and a chest fixation unit 434 and/or a lumbar fixation unit 436 as described above with respect to fixation unit 140 or 200. Load-bearing assembly 430 may be moved vertically along guide rails 412 and/or 414 by an actuator unit as described above with respect to FIG. 3. Even though chest fixation unit 434 and lumbar fixation unit 436 are shown as at fixed locations on load-bearing assembly 430 in FIG. 4, in some implementations, the locations of chest fixation unit 434 and/or lumbar fixation unit 436 on load-bearing assembly may be adjustable based on the patient's physical size.

Vertical traction system 400 may also include a cervical traction assembly 420 that may include a hook 422 and a component for holding the patient's head (e.g., a sling or a helmet) (not shown in FIG. 4). Cervical traction assembly 420 may be moved vertically along guide rails 414 and/or 412 by an actuator unit as described above with respect to FIG. 3.

In some implementations, vertical traction system 400 may also include a lumbar traction assembly 440 that may include one or more blocks 450 for applying additional pulling force to the lumbar spine or the thoracic spine, in addition to the force applied due to the weight of the lower body of the patient. Vertical traction assembly 420 may be moved vertically along guide rails 414 and/or 412 by an actuator unit, such as the one described above with respect to FIG. 3.

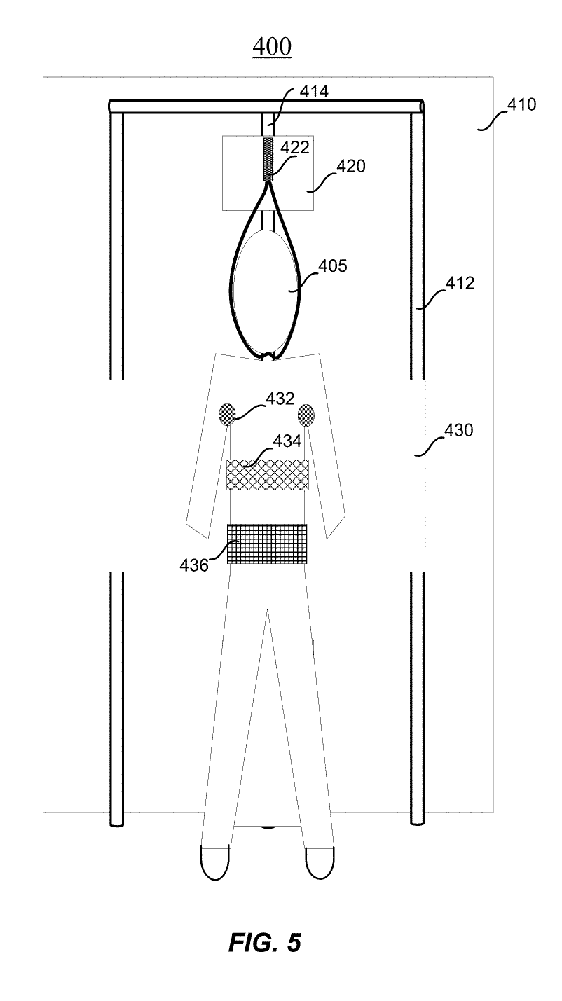

FIG. 5 is a simplified diagram illustrating a patient 405 under treatment on an example vertical traction system, such as vertical traction system 400 described above with respect to FIG. 4, according to an embodiment of the present invention. In FIG. 5, patient 405 is in the upright standing position on vertical traction system 400. The patient is secured to the vertical traction system in a desired position by chest fixation unit 434 and lumbar fixation unit 436. The patient is lifted off the base of the vertical traction system by load-bearing unit 430 with support from handrails 432 under the arms. Thus, the lumbar spine and/or thoracic spine may be pulled by the weight of the lower body of patient 405. At the same time, the cervical spine of patient 405 may be pulled by cervical traction assembly 420.

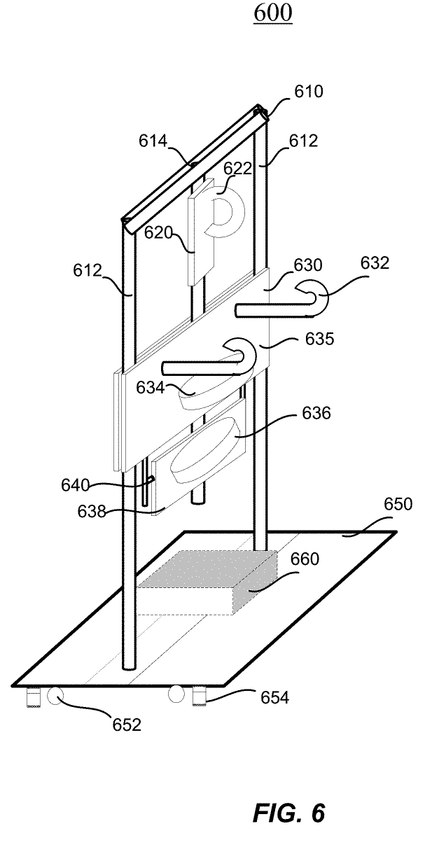

FIG. 6 is a simplified diagram illustrating another example vertical traction system 600, according to an embodiment of the present invention. As vertical traction systems 100 and 400, vertical traction system 600 may include a frame 610 that may include one or more guide rails 612 and/or 614. Vertical traction system 600 may include a base 650. Base 650 may include wheels 652 for moving vertical traction system 600 and dock levelers 654 for leveling and fixing vertical traction system at a location. In some implementations, at least some portions of base 650 may be foldable to further save space when vertical traction system 600 is not being used.

Vertical traction system 600 may include a load-bearing assembly 630 that may include handrails 632 and a chest fixation unit 634 and/or a lumbar fixation unit 636 as described above with respect to fixation unit 140 or 200. Load-bearing assembly 630 may be moved vertically along guide rails 612 by an actuator unit as described above with respect to FIGS. 3 and 4. In some implementations, the relative position of lumbar fixation unit 636 with respect to load-bearing assembly 630 may be independently adjusted. In some implementations, the relative position of chest fixation unit 634 and/or lumbar fixation unit 636 on load-bearing assembly 630 may be adjustable based on the patient's physical size. For example, lumbar fixation unit 636 may be located on a fixation plate 638, which can be moved up and down with respect to a base plate 635 of load-bearing assembly 630, and can be coupled to load-bearing assembly 630 through, for example, a bolt 640. In some implementations, base plate 635 of load-bearing assembly 630 may be flat. In some implementations, base plate 635 of load-bearing assembly 630 may have a curved shape or a “U” shape, such that the patient under treatment may be positioned in a plane defined by guide rails 612 and/or 614 for better balancing.

Vertical traction system 600 may also include a cervical traction assembly 620 that may include a hook 622 and a component for holding the patient's head (e.g., a sling or a helmet) (not shown). Cervical traction assembly 620 may be moved vertically along guide rails 414 and/or 412 by an actuator unit as described above with respect to FIG. 3 and FIG. 4.

In some implementations, vertical traction system 600 may include an optional removable support 660 on base 650. Removable support 660 may be moved horizontally or vertically on based 650. The patient may first stand on removable support 660 in the upright standing position and be attached to load-bearing assembly 630. Removable support 660 may then be moved horizontally or vertically on based 650, such that the feet of the patient may be at least partially off removable support 660 and the weight of the patient may no longer be fully supported by removable support 660. In this way, a force may be applied to the lumbar spine of the patient even if the load-bearing assembly 630 is not moved vertically.

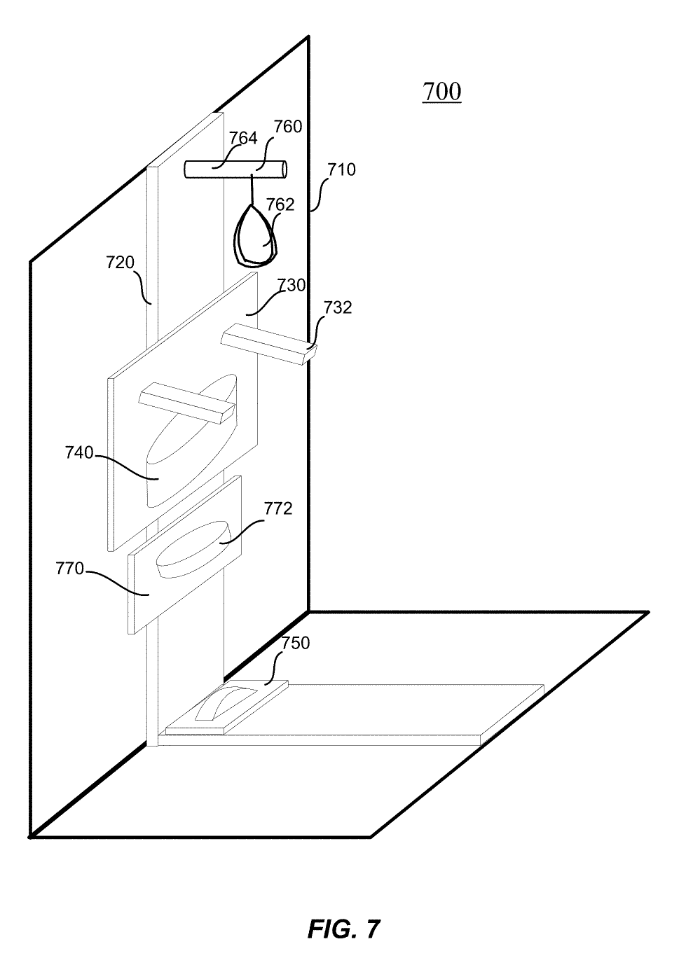

FIG. 7 is a simplified schematic diagram of an example vertical traction system 700, according to an embodiment of the present invention. As vertical traction system 100, vertical traction system 700 may include a frame 710, a load-bearing assembly 730, and a cervical traction assembly 760 and/or a lumbar traction assembly 750. Frame 710 may include wheels and a docking system that can be used to move and fix vertical traction system 700 at a desired location. Frame 710 may include a guide rail 720. Load-bearing assembly 730 may be configured to move up or down along guide rail 720. Load-bearing assembly 730 may include a pair of handrails 732 and one or more fixation units 740. A fixation unit 740 may be used to attach a patient to load-bearing assembly 730 at, for example, the chest, such that the patient may be held at a stable and secure position when being lifted upright by load-bearing assembly 730. Handrails 732 may be used to at least partially support the patient in an upright position under the arms of the patient to lift the patient up or down when load-bearing assembly 730 moves vertically.

Cervical traction assembly 760 may be similar to or different from cervical traction assembly 160. Cervical traction assembly 760 may include a sling 762 comprising a fabric, leather, synthetic, or other soft materials. Sling 762 may be configured to move around a support 764 (e.g., through a pulley) and hold the patient's head at the neck or the chin. Sling 762 can be pulled up relative to load-bearing assembly 730, for example, through an actuator unit (e.g., actuator unit 300), to pull the head upwards with respect to other parts of the body, in order to pull the cervical spine of the patient. In some implementations, cervical traction assembly 760 may include a component other than a sling, such as a helmet, for pulling the patient upwards at the head.

In some implementations, vertical traction system 700 may also include a lumbar fixation unit 772 on a lumbar fixation plate 770. As load-bearing assembly 730, lumbar fixation plate 770 may be independently moved vertically along guide rail 720 through an actuator unit, such as actuator unit 300. Lumbar fixation unit 772 may be similar to fixation unit 140 or 200, and may be attached to the waist of the patient. Lumbar fixation unit 772 may be moved vertically with lumbar fixation plate 770 to provide upward support to the lumbar spine or pull the lumbar spine downwards.

The above description of example embodiments of the vertical traction system has been presented for the purposes of illustration and description. It is not intended to be exhaustive or to limit the invention to the precise form described, and those skilled in the art can appreciate that many modifications and variations are possible in light of the teaching above.

### II. Example Methods

As described above, with a vertical traction system as disclosed herein, patients with degenerative spine conditions, spinal compression, or other spinal problems may be treated more effectively by simultaneously treating bones (e.g., spine) and muscles in a working condition while a subject under treatment is in an upright standing position.

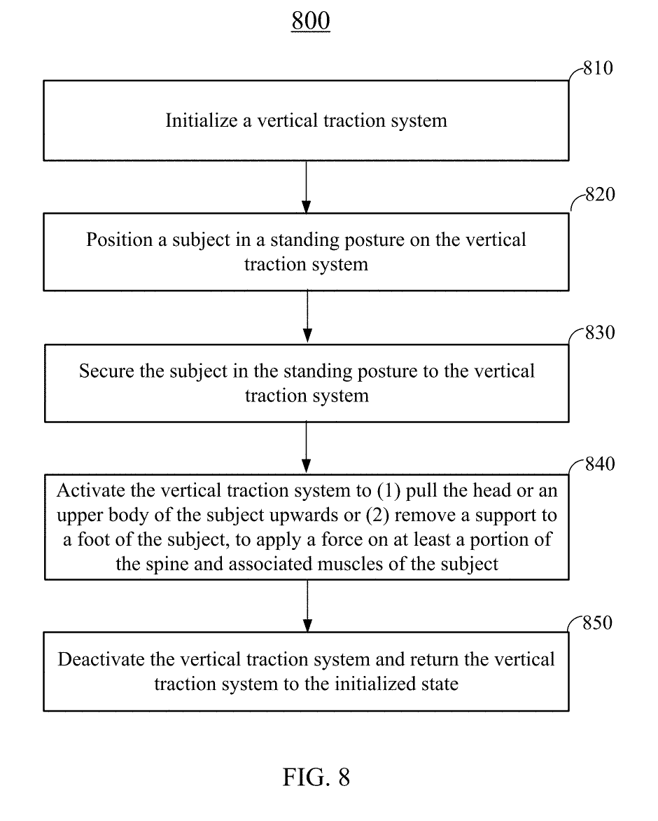

FIG. 8 is a simplified flowchart illustrating a method of operating a vertical traction system, according to an embodiment of the present invention. At block 810, the vertical traction system may be initialized to a state based on the physical sizes and/or treatment needs of a subject to be treated with the vertical traction system. This may include, for example, adjusting the positions of the load-bearing assembly, the chest fixation unit and/or the lumbar fixation unit, or the cervical traction assembly, etc. In some implementations, initializing the vertical traction system may include loading a patient-specific treatment recipe on the vertical treatment system.

At block 820, the subject to be treated may be positioned in an upright standing posture on the vertical traction system. For example, the subject can be instructed by a medical personnel or the user interface of the vertical traction system to stand on the vertical traction system with arms on the handrails. The subject may be instructed to rotate the body as needed.

At block 830, the subject to be treated may be secured in the upright posture on the vertical traction system. For example, the subject can be attached to the load-bearing assembly through the chest fixation unit and/or the lumbar fixation unit.

At block 840, the vertical traction system may be activated to pull a head or an upper body of the subject upwards to apply a force on at least a portion of the spine and associated muscles of the subject. In some cases, the subject may suffer from cervical spinal pains; the head of the subject may be attached to the cervical traction assembly of the vertical traction assembly and be pulled by the cervical traction assembly. In some cases, the subject may suffer from lumbar spinal pain; the subject may be pulled up by the load-bearing assembly such that the lumbar spine and associated muscles may be pulled downwards by the lower part of the body of the subject. In some case, additional lumbar traction assembly may be used to apply more force to the spine as described above. As also described above, the desired pulling force, pulling speed, and the maximum extension for different body parts, the number of pulling cycles at each selected pulling force and speed may also be programmed, and a series of pulling operations may be performed. In some implementation where the vertical traction system includes a removable support, such as removable support 660 of FIG. 6, rather than pulling the upper body of the subject upwards to apply a force on at least a portion of the spine and associated muscles of the subject, removable support 660 may be moved horizontally or vertically, such that the weight of the patient may no longer be fully supported by removable support 660. In this way, a force may be applied to the lumbar spine of the patient even if the load-bearing assembly is not moved vertically.

At block 850, after the treatment is complete, the vertical traction system may be deactivated and returned to the initialized state. The vertical traction system may then be used for a different subject or for a different treatment for the same subject.

In this way, the bones and muscles associated with the spine may be simultaneously treated in a working condition, and more consistent results may be achieved.

### III. Computer System

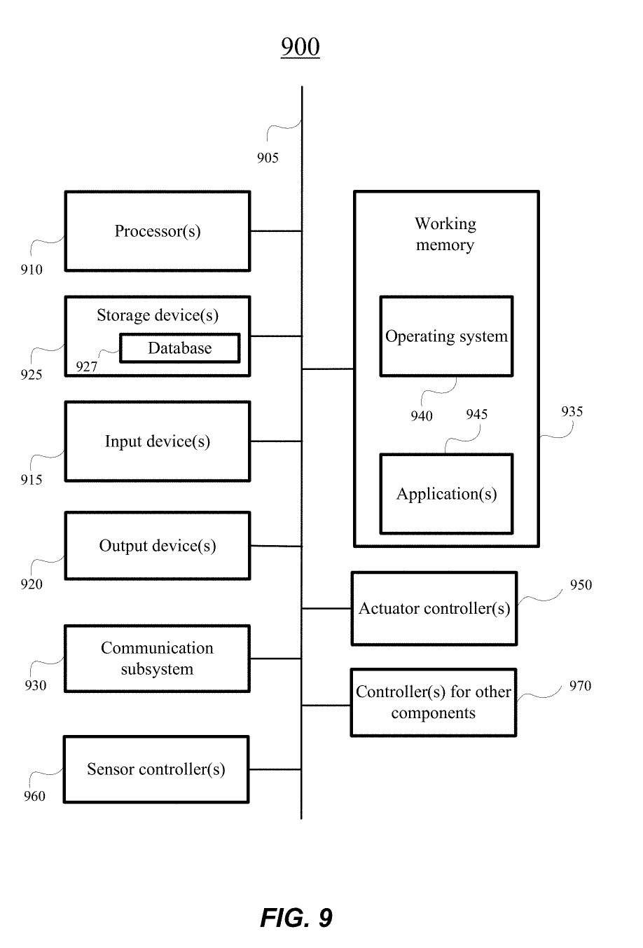

FIG. 9 illustrates an example computer system 900 incorporating at least parts of the device or system employed in practicing embodiments of the disclosure. For example, computer system 900 may represent some of the components of a control subsystem. FIG. 9 provides a schematic illustration of one embodiment of computer system 900 that may perform the methods provided by various other embodiments, as described herein. FIG. 9 is meant only to provide a generalized illustration of various components, any or all of which may be utilized as appropriate. FIG. 9, therefore, broadly illustrates how individual system elements may be implemented in a relatively separated or relatively more integrated manner.

Computer system 900 is shown comprising hardware elements that may be electrically coupled via a bus 905 (or may otherwise be in communication, as appropriate). The hardware elements may include one or more processors 910, including, without limitation, one or more general-purpose processors and/or one or more special-purpose processors (such as digital signal processing chips, graphics acceleration processors, and/or the like); one or more input devices 915, which may include, without limitation, a touch screen, a mouse, a keyboard and/or the like; and one or more output devices 920, which may include, without limitation, a display unit, a printer and/or the like.

Computer system 900 may further include (and/or be in communication with) one or more non-transitory storage devices 925, which may comprise, without limitation, local and/or network accessible storage, and/or may include, without limitation, a disk drive, a drive array, an optical storage device, a solid-form storage device such as a random access memory (“RAM”) and/or a read-only memory (“ROM”), which may be programmable, flash-updateable and/or the like. Such storage devices may be configured to implement any appropriate data storage, including, without limitation, various file systems, database structures, and/or the like, such as a patient-specific treatment recipe.

Computer system 900 may also include a communications subsystem 930. Communications subsystem 930 may include a transceiver for receiving and transmitting data or a wired and/or wireless medium. Communications subsystem 930 may also include, without limitation, a modem, a network card (wireless or wired), an infrared communication device, a wireless communication device and/or chipset (such as a Bluetooth® device, an 802.11 device, a WiFi device, a WiMax device, cellular communication facilities, etc.), and/or the like. Communications subsystem 930 may permit data to be exchanged with a network, other computer systems, and/or any other devices described herein. In many embodiments, computer system 900 may further comprise a non-transitory working memory 935, which may include a RAM or ROM device, as described above.

Computer system 900 may comprise software elements, shown as being currently located within the working memory 935, including an operating system 940, device drivers, executable libraries, and/or other code, such as one or more application programs 945, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions may be used to configure and/or adapt a general purpose computer (or other device) to perform one or more operations in accordance with the described methods.

A set of these instructions and/or code might be stored on a computer-readable storage medium, such as storage device(s) 925 described above. In some cases, the storage medium might be incorporated within a computer system, such as computer system 900. In other embodiments, the storage medium might be separate from a computer system (e.g., a removable medium, such as a compact disc), and/or provided in an installation package, such that the storage medium may be used to program, configure and/or adapt a general purpose computer with the instructions/code stored thereon. These instructions might take the form of executable code, which is executable by computer system 900 and/or might take the form of source and/or installable code, which, upon compilation and/or installation on computer system 900 (e.g., using any of a variety of generally available compilers, installation programs, compression/decompression utilities, etc.) then takes the form of executable code.

As described above, a vertical traction system may include various actuator units, sensors, and other components, such as a heat generator and massage subsystem. Computer system 900 may include actuator controller(s) 950 for controlling the operations of the actuator units, sensor controller(s) 960 for controlling the operations of the sensors and receiving measurement data from the sensors, and controller(s) 970 for other components of the vertical traction system.

Substantial variations may be made in accordance with specific requirements. For example, customized hardware might also be used, and/or particular elements might be implemented in hardware, software (including portable software, such as applets, etc.), or both. Further, connection to other computer systems 900 such as network input/output devices may be employed.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A vertical traction system comprising:
a frame;
a load-bearing assembly coupled to the frame, the load-bearing assembly configured to move vertically and support a subject under treatment in an upright position while the load-bearing assembly moves vertically; and
a spinal traction assembly coupled to the frame, the spinal traction assembly configured to pull the cervical or lumbar spine of the subject.

2. The vertical traction system of claim 1 wherein the load-bearing assembly comprises:
a pair of handrails configured to support the subject under arms of the subject while the load-bearing assembly moves vertically; and
a fixation unit configured to attach the subject to the load-bearing assembly.

3. The vertical traction system of claim 2 wherein the fixation unit is configured to attach the load-bearing assembly to at least one of the chest or the lumbar of the subject.

4. The vertical traction system of claim 2 wherein the fixation unit comprises:
an extendable rod coupled to a fixation plate of the load-bearing assembly; and
a binding unit fixedly or movably coupled to the extendable rod.

5. The vertical traction system of claim 1 further comprising an actuator unit, wherein the actuator unit comprises:
a pulley coupled to the frame; and
a cable, wherein a first end of the cable is coupled to the load-bearing assembly, a second end of the cable is coupled to the frame, and the cable is configured to slide over the pulley.

6. The vertical traction system of claim 5 further comprising a motor, wherein:
the motor is coupled to the frame; and
the second end of the cable is coupled to the frame through the motor.

7. The vertical traction system of claim 6 wherein the actuator unit further comprises a first gear and a second gear, wherein:
the first gear is coupled to an output shaft of the motor;
the second gear is coupled to the second end of the cable; and
the second gear is moveable relative to the first gear such that the first gear and the second gear are configurable to be engaged with or disengaged from each other.

8. The vertical traction system of claim 5 further comprising a motor, wherein:
the motor is coupled to the load-bearing assembly; and
the first end of the cable is coupled to the load-bearing assembly through the motor.

9. The vertical traction system of claim 1 wherein the spinal traction assembly comprises at least one of a cervical traction assembly or a lumbar traction assembly.

10. The vertical traction system of claim 9 wherein the cervical traction assembly comprises:
a sling configured to hold the head of the subject;
a pulley coupled to the frame;
a motor coupled to the frame; and
a cable, wherein a first end of the cable is coupled to the sling, a second end of the cable is coupled to the motor, and the cable is configured to slide over the pulley.

11. The vertical traction system of claim 10 wherein the cervical traction assembly further comprises a first gear and a second gear, wherein:
the first gear is coupled to an output shaft of the motor;
the second gear is coupled to the second end of the cable; and
one of the first gear or the second gear is moveable relative to the other gear such that the first gear and the second gear are configurable to be engaged with or disengaged from each other.

12. The vertical traction system of claim 9 wherein the lumbar traction assembly comprises:
one or more blocks;
a pulley coupled to the frame;
a motor coupled to the frame; and
a cable, wherein a first end of the cable is coupled to the one or more blocks, a second end of the cable is coupled to the motor, and the cable is configured to slide over the pulley.

13. The vertical traction system of claim 12 wherein the lumbar traction assembly further comprises a first gear and a second gear, wherein:
the first gear is coupled to an output shaft of the motor;
the second gear is coupled to the second end of the cable; and
the second gear is moveable relative to the first gear such that the first gear and the second gear are configurable to be engaged with or disengaged from each other.

14. The vertical traction system of claim 1 further comprising a control subsystem configured to control operations of the load-bearing assembly and the spinal traction assembly.

15. A method of operating a vertical traction system, the method comprising:
attaching a subject in an upright position to the vertical traction system; and
activating the vertical traction system to (1) pull the head or the upper body of the subject upwards or (2) remove a support to a foot of the subject, while the subject remains in the upright position, to apply a force on at least a portion of the spine and associated muscles of the subject.

16. The method of claim 15 wherein attaching the subject in the upright position to the vertical traction system includes:
supporting the subject under the arm; and
fastening a binding unit of the vertical traction system on at least one of a chest or lumbar of the subject.

17. The method of claim 15 wherein attaching the subject in the upright position to the vertical traction system further includes:
attaching a sling under the chin of the subject.

18. The method of claim 17 wherein activating the vertical traction system causes the head of the subject be pulled at the chin by the sling.

19. The method of claim 15 wherein activating the vertical traction system causes the upper body of the subject be pulled at the arm or the support to the foot of the subject be removed, such that at least a portion of the weight of the subject is not supported by the feet of the subject.

20. The method of claim 15 further comprising activating the vertical traction system to pull the legs or feet of the subject downwards while the subject remains in the upright position.
